(19) United States
(12) Patent Application Publication
(10) Pub. No.: US 2012/0203365 A1
(43) Pub. Date: Aug. 9, 2012

(54) METHOD AND DEVICE FOR GENERATIVELY MANUFACTURING A THREE-DIMENSIONAL OBJECT WITH THREE-DIMENSIONAL CODED CHARACTER

(76) Inventors: Ludger Hümmeler, Lennestadt (DE); Florian Pfefferkorn, Munchen (DE); Manfred Semmler, Memmingen (DE); Markus Schmidtner, Utting am Ammersee (DE); Markus Frohnmaier, Munchen (DE)

(21) Appl. No.: 13/259,653

(22) PCT Filed: Sep. 27, 2010
(86) PCT No.: PCT/EP10/05889

§ 371 Date: Dec. 16, 2011

(30) Foreign Application Priority Data
Sep. 28, 2009 (DE) 10 2009 043 317.1

(51) Int. Cl. G05B 15/00

(52) U.S. Cl. 700/98

(57) ABSTRACT

The present invention relates to a method and to a device for generatively manufacturing a three-dimensional object (3). A powdery material (11) is applied layerwise onto a support (5) of the device or onto a previously applied layer, and the powdery material (11) is solidified by energetic radiation (8′) at locations corresponding to the object (3). The powdery material (11) is solidified such that a digital, machine readable and three-dimensional coded character is provided at a surface of the object (3).

The present invention relates to a method and to a device for manufacturing a three-dimensional object.

WO 2005/099635 A1 describes a method of manufacturing a three-dimensional object which contains inside an identifiable structure. The identifiable structure consists of a contrast agent and can be viewed by X-rays, for example. U.S. Pat. No. 6,939,501 B2 describes a semiconductor device, onto which a sequence of letters or numbers is set by means of stereolithography. WO 02/24127 A2 describes a method of manufacturing an otoplastic, in particularly an in-ear hearing device, for example by laser-sintering, wherein the otoplastic comprises notches and/or bulges at the surface. The notches and/or bulges define a machine readable marking of the otoplastic. The notches and/or bulges are usually two-dimensional coded because they bear information which is defined by the length and depth of the notches and/or bulges.

In laser-sintering, the manufactured objects must usually be marked for quality control. Up to now, this has been made by a writing (label) consisting of a sequence of letters or numbers which are sintered on or into the object. The writing shall be created by the laser-sintering device directly at the objects, because later allocation of the information to the objects is hardly possible when many objects (for example some hundreds) are manufactured in one job and the objects are then withdrawn from the laser-sintering device. Then, the objects cannot unambiguously be allocated to the job and to the previous position within the building space anymore. A further problem is caused for small objects which offer only a small space for the writing. Due to the process, the writing can also be provided only with a predetermined width, height and resolution.

It is the object of the present invention to provide a method and a device for manufacturing a three-dimensional object, which are capable to mark the object with much information as possible.

This object is achieved by the method of manufacturing a three-dimensional object having the features of claim 1 and by the device for manufacturing a three-dimensional object having the features of claim 11.

Advantageously, back tracking (tracking) of the object is possible by the marking. Advantageous further developments are subject of the dependent claims.

Further aims and purposes of the invention can be gathered from the description of embodiments on the basis of the enclosed drawings. In the drawings show:

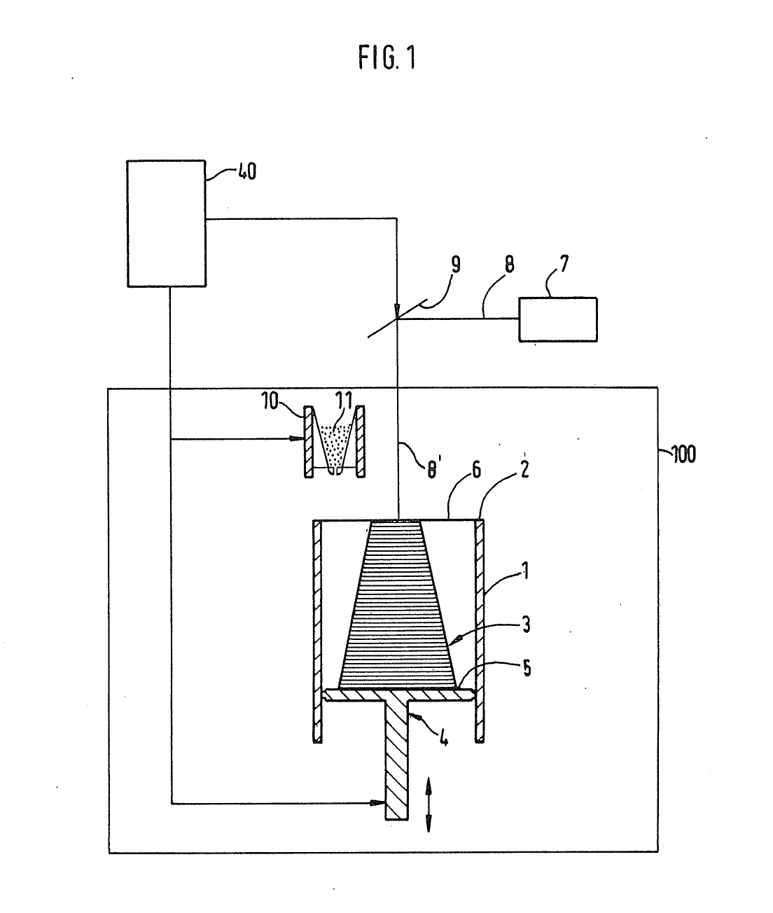

FIG. 1 a schematic view of a device for manufacturing a three-dimensional object according to the present invention;

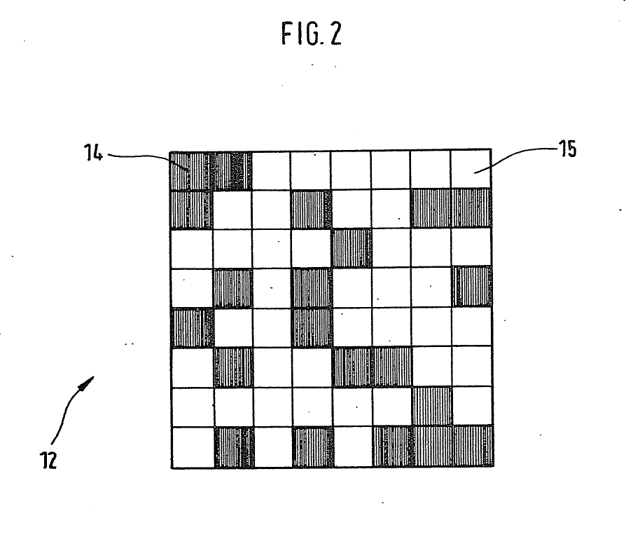

FIG. 2 a top view of a three-dimensional coded character according to a first embodiment of the present invention;

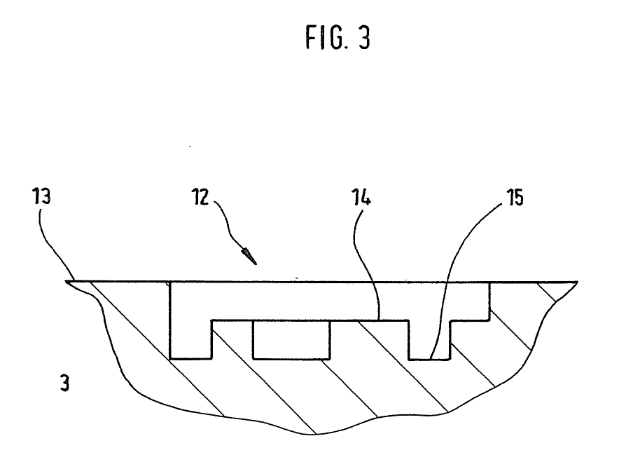

FIG. 3 a cross-sectional view of the three-dimensional coded character according to the first embodiment of the present invention;

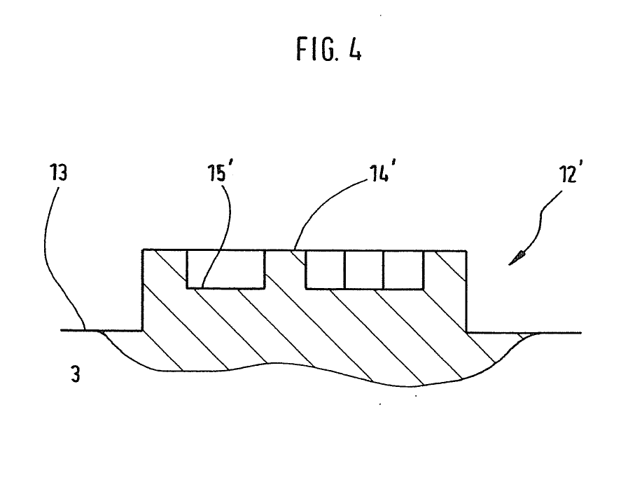

FIG. 4 a cross-sectional view of a three-dimensional coded character according to a second embodiment of the present invention; and

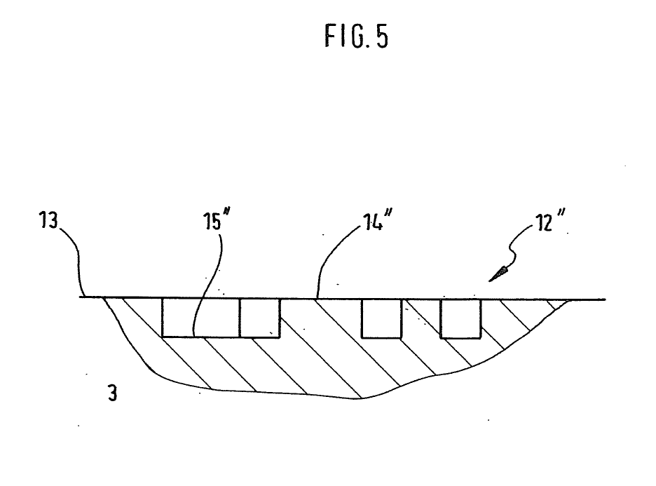

FIG. 5 a cross-sectional view of a three-dimensional coded character according to a third embodiment of the present invention.

FIG. 1 shows a schematic view of a device for manufacturing a three-dimensional object 3 according to the present invention, which is formed as laser-sintering device in the embodiment.

The laser-sintering device comprises a frame 1 which opens at the top and comprises therein a platform 5, which is movable in the vertical direction and supports the three-dimensional object 3 to be manufactured. The frame 1 and the platform 5 define therein a building space. The platform 5 is connected to a lift mechanics 4, by which it is moved in the vertical direction such that the layer of the object 3, which should be solidified, lies within a working plane.

Further, an applicator 10 for applying a layer of a powdery material 11 is provided. As powdery material 11, all laser-sintering powders can be used such as laser-sinterable plastics like polyamide, polystyrene, and in particular high-temperature plastics like PEEK, metals, ceramics, moulding sand and compound materials. As metal containing powdery material, any metals and alloys thereof as well as mixtures of metallic components or non-metallic components come into question. First, the powdery material 11 is supplied to the frame 1 from a storage container of the applicator 10. Thereafter, the applicator 10 is moved to a predetermined height above the upper periphery 2 of the frame 1 within the working plane 6 so that the layer of the powdery material 11 lies in a defined height above the lastly solidified layer. Further, the device comprises a laser 7 which generates a laser beam 8, 8′ which is focussed to arbitrary points in the working plane 6 by deflection means 9. Thereby, the laser beam 8, 8′ can selectively solidify the powdery material 11 at the locations corresponding to the cross-section of the object 3 to be manufactured.

Reference sign 100 designates a process chamber, in which the frame 1, the platform 5, the lift mechanics 4 and the applicator 10 can be arranged. The process chamber 100 has in the upper area an opening for introducing the laser beam 8, 8′. Preferably, an inert gas is introduced into the process chamber 100. Further, a control unit 40 is provided, by which the device is controlled in a coordinated manner so as to execute the building process.

During operation of the device, the platform 5 is lowered by the lift mechanics 4 in a first step, until the upper side thereof lies below the working plane 6 by the thickness of one layer. Then, a first layer of the powdery material 11 is applied and smoothened on the platform 5 by the applicator 10. Thereupon, the control unit 40 controls the deflection means 9 such that the deflected laser beam 8, 8′ selectively impinges at those locations of the layer of the powdery material 11, which shall be solidified. Thereby, the powdery material 11 is solidified and/or sintered at these locations, so that the three-dimensional object 3 is created here.

In a next step, the platform 5 is lowered by the lift mechanics 4 by the thickness of the next layer. A second layer of powdery material is applied, smoothened by the applicator 10 and selectively solidified by means of the laser beam 8, 8′. These steps are repeated until the desired object 3 is manufactured.

The three-dimensional objects 3 have a digital, machine readable and three-dimensional coded character 12 according to the present invention. The character 12 contains information such as a time stamp, the position of the object 3 within the device, the job number, the material of the object 3, etc. Such information can be used for quality control. FIG. 2 shows a top view of the three-dimensional codes character 12 according to a first embodiment of the present invention, and FIG. 3 shows a cross-sectional view of the three-dimensional coded character 12 according to the first embodiment.

In the first embodiment, the character 12 defines in a surface 13 of the three-dimensional object 3 a two-dimensional matrix 12, wherein the matrix 12 comprises a given number of components 14, 15. Preferably, the matrix 12 is larger than a 2×2-matrix, and in the first embodiment according to FIG. 2, the matrix 12 is a 8×8-matrix. For example, the respective components 14, 15 of the matrix 12 as shown in FIG. 2 may be quadrates with an edge length of 0.8 mm. Advantageously, the computing power of the control unit 40 for manufacturing the matrix 12 is relatively small and constant, when this is compared with the computing power for a character string of letters and numbers.

The components 14, 15 of the matrix 12 have different distances (heights or depths) from the surface 13 of the object 3. FIG. 3 shows that the matrix 12 comprises first components 14 having a first distance from the surface 13 of the object 3, and second components 15 having a second distance from the surface 13. In the first embodiment, the first components 14 as well as the second components 15 of the matrix 12 form depressions in the surface 13 of the object 3. However, the first components 14 of the matrix 12 have a smaller distance from the surface 13 than the second components 15 of the matrix 12.

FIG. 4 shows a cross-sectional view of the three-dimensional coded character 12′ according to a second embodiment of the present invention, wherein the first component 14′ as well as the second component 15′ of the matrix 12′ form embossments from the surface 13 of the object 3. However, the first components 14′ of the matrix 12′ have a larger distance from the surface of the object 3 than the second components 15′ of the matrix 12′.

FIG. 5 shows a cross-sectional view of a three-dimensional coded character 12″ according to a third embodiment of the present invention, wherein the first components 14″ are substantially aligned to be flush with the surface 13 of the object 3, and the second components 15″ are depressed in the surface 13. In a modification of the third embodiment, the second components 15″ may be embossed from the surface 13, while the first components 14″ are substantially aligned to be flush with the surface 13.

According to the present invention, the three-dimensional coded signs 12; 12′; 12″ are digital and machine readable. For example, an embossed and/or higher component 14; 14′; 14″ of the matrix 12; 12′; 12″ may represent the binary 1, while a depressed and/or lower component 15; 15′; 15″ of the matrix 12; 12′; 12″ represents the binary 0, or vice versa. The 8×8-matrix 12 as shown in FIG. 2 therefore defines a word of 64 bit.

Reading the character 12; 12′; 12″ is performed by machine, for example by pin scanning, laser scanning or by means of a CCD-camera having downstream a pattern recognition. In order to easily read the character 12; 12′; 12″, the first components 14; 14′; 14″ of the matrix 12; 12′; 12″ preferably have another surface property than the second components 15; 15′; 15″ of the matrix 12; 12′; 12″. In particular, the surface property may be a surface roughness or a reflection coefficient.

A further embodiment may comprise a step of tinting a part of the components. For example, this can be made in the second embodiment of FIG. 4 by pressing the character 12′ against an ink pad which is saturated with paint or ink. Thereby, only the first components 14′ are tinted.

In the third embodiment of FIG. 5, a paint or a finish can be applied on the character 12″, and in a subsequent step, the character 12″ is wiped off by a wiper so that the colour or the finish only remains on the depressed second components 15″ of the matrix 12″.

The scope of protection is not restricted to the represented embodiments, but it also includes further changes and modifications, provided that they fall within the scope as defined by the enclosed claims.

The method according to the present invention is not only applicable to laser-sintering, but also to all generative methods based on powder, where a single material and/or a single powdery material is used in one applied layer which is solidified by the energetic beam. If necessary, the single material and/or the single powdery material is added by an activator. The energetic beam must not necessarily be a laser beam, but it can also be an electron beam, for example.

The structure of the digital, machine readable and three-dimensional coded character 12 is not restricted to the shape of a matrix. Instead, an arbitrary 3D code can be used.

1. Method of generatively manufacturing a three-dimensional object by means of a device, comprising the following steps:
layerwise applying a powdery material onto a support of the device or a previously applied layer;
solidifying the powdery material by energetic radiation at locations corresponding to the object,
wherein the powdery material is solidified such that a digital, machine readable and three-dimensional coded character is provided at a surface of the object.

2. Method according to claim 1, wherein the character defines a two-dimensional matrix in the surface of the three-dimensional object, wherein the matrix has a plurality of components having different distances from the surface of the object.

3. Method according to claim 2, wherein the matrix comprises a first component having a first distance from the surface of the object and a second component having a second distance from the surface of the object.

4. Method according to claim 3, wherein the first component is substantially aligned to be flush with the surface of the object, and the second component is embossed from the surface of the object or depressed in the surface.

5. Method according to claim 2, wherein the first components of the matrix comprise a different surface property from the second components of the matrix.

6. Method according claim 2, further comprising a step of applying a paint or a finish on those components which have a certain distance from the surface of the object.

7. Method according to claim 2, wherein the matrix is surrounded by a frame which has a different height or a different surface property from the surface of the object.

8. Method according to claim 1, wherein only a single powdery material, which is, if necessary, provided with an activator, is used for one layer.

9. Method according to claims 2, wherein a component of the matrix bears binary information.

10. Laser-sintering method as the method according to claim 1.

11. Device which performs the method according to claim 1.
